(19) United States
(12) Patent Application Publication
(10) Pub. No.: US 2003/0146926 A1
(43) Pub. Date: Aug. 7, 2003

(54) Communication system

(76) Inventor: Wesley Valdes, Oak Lawn, IL (US)

Correspondence Address: Steven B. Courtright, BANIAK PINE & GANNON, Suite 1200, 150 N. Wacker Drive, Chicago, IL, 60606, US

(21) Appl. No.: 10/348,728

(22) Filed: Jan. 22, 2003

Related U.S. Application Data
(60) Provisional application No. 60/350,768, filed on Jan. 22, 2002.

(51) Int. Cl. G09G 5/00

(52) U.S. Cl. 345/703; 345/864

(57) ABSTRACT

A device and method is provided for communicating between a service provider and a service receiver that speak and understand different languages. The device includes a microprocessor, random access memory, program storage, data storage, at least one input device, at least one output device, and a software program that stores pre-translated questions and statements of the translations associated with those questions and statements, such questions enabling communication between the provider and the receiver. The method includes determining the language of the service and providing the translated questions and statements and receiving responses to those questions. The questions and statements are transmitted based on determining the receiver language in one or both of text and audio formats. Responses are collected based on the transmitting of the questions and statements; and information is provided in the provider's language, based on the responses; where the provider's language is different from the receiver's language.

### APPLICATION HISTORY

This application claims the benefit of U.S. Provisional Application No. 60/350,768, filed Jan. 22, 2002. A portion of the disclosure of this patent document contains material that is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### FIELD OF THE INVENTION

The present invention relates to an apparatus and method for assisting in the transmission of information between users that do not speak the same language, and in particular, the present invention relates to an apparatus and method for allowing a doctor, nurse or caregiver to provide assistance to a patient that does not speak the same language.

### BACKGROUND OF THE INVENTION

There are many industries in which the accurate communication of information is of utmost import. These industries include but are not limited to medicine, law enforcement, education, transportation, finance, customs, and military. The failure to properly communicate information may, in some instances, mean the difference between life and death.

On Aug. 11, 2000 President Clinton issued Executive Order 13166 stating that all federal agencies, by Dec. 11, 2000, establish written policies on the language-accessibility of their programs and the programs of those who receive federal funds. Federal agencies and recipients of federal financial assistance must take reasonable steps to ensure that persons with limited English proficiency can meaningfully access their programs. This executive order effectively amended limited English proficiency to Title VI of the Civil Rights Act of 1964.

What this means to hospitals is that accurate and meaningful translation capabilities must be provided to assure that all patients have access to the same level of health care. Hospitals attempt to comply with either the use of hospital employees identified as bilingual in a foreign language, staff translators, or the use of third party translation services accessible by telephone.

There have been a number of studies showing an unacceptable high rate of miscommunication with the use of an interpreter. Medical information is critical and subtle changes by an interpreter can alter the doctor's perception of a patient's medical problem. Current solutions of using a live interpreter over-the-telephone-interpreter, or family member are inadequate as both the patient and the doctor are forced to trust a non-medically trained person to translate and interpret medical information. Further, using a live interpreter, especially one having experience in the medical field, can be extremely expensive or not immediately available.

In industries such as medicine, the collection of information can be time critical. The identification of a patient's native language and the location of a translator can take valuable time. In emergency situations, delays in obtaining information can have a deleterious patient outcome.

The transmission of information between two individuals that speak different languages, through an interpreter, goes back as far as recorded history. Translating information, or communicating with one who does not speak a similar language, has occurred in many ways. One of the ways of translating information between such parties is through an interpreter that knows the language of both parties trying to communicate. An interpreter can listen to the first party's statement or question, and translate it into the language that the second party understands. The interpreter can then translate the response or answer from the second party into the language that the first party understands. Of course, when such a translation is accomplished, errors may occur. This is especially true when the translator has no experience with the subject matter that the two parties may be discussing. In fact, the use of interpreters has been shown in scientific studies to be an inaccurate method of relaying information.

Another way of communicating information between two parties that speak different languages is to use static printouts. These printouts are used to correlate particular information (or a question) with a particular pictures. Although this method may work in certain situations, i.e., when time and accuracy are not of the essence, this method is futile and impractical in most situations where there is a lot of information that must be relayed. A static question list (or picture) doesn't allow for enough questions, especially in the medical field, and to do so would be much too bulky.

In the healthcare field, one method used in the past for translating information between a doctor, for example, and a patient that speaks a different language, has been to use hospital employees (that understand both languages), family members, or trained interpreters, if available. As the laws have changed, the amended Title VI has forced hospitals that receive federal funding to require that interpreters be available. for patient care, especially if the population that the hospital serves has a significant presence of a particular (non-English) language. Other alternatives employed have been to use interpreter banks, in which a central location is set up where interpreters will be working and translation and interpretation can be performed through the use of a telephone.

The device described in the specification of U.S. Pat. No. 5,964,700 ostensibly provides a health professional answering telephone calls (received through a telephone service). Each answer is either a “yes” or “no” to questions based on branched chain logic algorithm in an attempt to assess a patient's medical needs. The object of the system is to integrate a health care organization's medical provider database and thereby direct the patient to an appropriate physician. The device described in the patent does not pertain to the translation of questions between a caregiver and a patient that speaks another language. Nor does the specification pertain to direct patient-doctor interaction in any way whatsoever.

The prior art further proposes a system for administering medical questionnaires. In U.S. Pat. No. 5,572,421 a system is described that seems to collect a patient's medical history and processes this data to recommend pre-operative tests as well as calculate a numerical measure of the patient's health. This system does not address translation between the caregiver and the patient, nor any patient-doctor interaction.

U.S. Pat. No. 4,428,733 ostensibly describes a system for gathering patient information on paper, of which those patients may speak a different language. The disclosed system fails to address the collection of information from patients that communicate in a language that is not known to the caregiver. The system is severely limited in use for patient-doctor interaction because it uses a static presentation of questions and is not feasible to provide the depth of information that a doctor would need to know. This lack of information from a patient can be extremely detrimental during the diagnostic phase of an interview.

Further, PrimeCare Systems, Inc. has developed and sold a system called the PrimeCare System, which allows the collection of medical history information from a patient and allegedly creates an electronic patient record from that information. It is believed that this product can be purchased in both an English and a Spanish version. The product is entirely driven by the patient inputting answers in response to questions. There is no audio component.

As seen below, the present invention provides an apparatus and method for allowing a doctor or caregiver to communicate information and questions to a patient that speaks another language, and for that caregiver to receive answers and information from the patient.

### SUMMARY OF THE INVENTION

The present invention is an apparatus and method which quickly determines the language in which one person communicates, and then the present invention transmits predetermined questions and/or statements to the person, translated into both text and optional sound recordings, in the language the person understands. The questions are intended to target both the collection of information as well as transmission of instructions and information.

One of the uses of the present invention would be between a doctor and a patient. In a situation where a patient requires assistance, but speaks a different language than a doctor, the present invention quickly determines the language in which the patient can communicate. The device then provides a series of questions or statements, in a language that the patient understands. The questions can be provided in text form in the language of the caregiver and on selection will display the related question in the language of the patient in both audio and a visual format via the display or monitor of a computer, Tablet PC, PDA, cell phone, etc.; or the questions or information can be transmitted by voice through a speaker or transducer of a computer, tabled PC, PDA, cell phone, etc. Additional questions or statements may be provided based on the answers to the various questions. The answers to these questions, or responses to the statements, provide information to the doctor allowing a diagnosis to be made. This diagnosis can be accomplished whether or not the doctor understands the patient's verbal response, since the patient's response into the device provides the information necessary to make a determination. Other settings in which the present invention would be useful include, for example, military, government, law enforcement, travel, mail delivery, and hotels/motels where there is a need to provide translation of a different language. The present invention contemplates the display of visual information as pictures, icons, video, text and graphics, etc.

A more specific example (from the medical industry) would be a situation where a physician does not speak the same language as a patient. The process would allow for questions to be presented by the physician or the physician's assistants, through the display of a Tablet PC, for example, to the patient regarding the patient's illness and inform the patient of exams the physician would be performing. The process would also allow for information to be dispensed to a patient or caregiver. For example, the doctor may wish to give advice as to lifestyle changes, explain medications and their side effects, or an explanation of medical procedures necessary for the care of the patient.

The primary intent of this invention is to use a device and method to assist in the collection and communication of critical information when a patient or service receiver does not speak a language familiar to a doctor or a service provider. The present invention comprises a microprocessor (or other Central Processing Unit), a random access memory, along with program and data storage, at least one, but probably several, I/O (Input/Output) devices for entering data and transmitting data. Such I/O devices might include for example, a keyboard, a touch screen, a microphone, voice recognition, character recognition as used on PDAs, Pocket PCs and Tablet PCs, for example, a display screen or monitor (possibly one and the same as the touch screen), a speaker, etc. The device might communicate with a similar device such that both the physician and the patient can access the questions, statements and answers at the same time in their own language. The device might also contain connections (either wired or wireless) for communicating or transmitting the collected information from the device to other systems, through a Local Area Network, a Wide Area Network, the Internet, etc. Such transmissions can be done in a variety of ways, using various security measures, known by one having ordinary skill in the art, such as Bluetooth, through a USB, or other, connection, etc.

The present invention incorporates pre-translated questions and information typically dispensed by those skilled in the service. For example, once the system determines that the patient speaks Spanish, the patient may be asked in Spanish, “does you head hurt?” Depending on the answer, the next set of logical questions would be presented. The translated data is stored in memory or an associated storage device.

The questions are displayed to the patient or user via the display screen, or the speaker may play an audible version of the question or statement for the user. The user then answers the question either using the device or answering the question verbally, by shaking or nodding his head or some other universal sign of yes or no. Either way the answer is entered via the I/O device. As described above, the answers are stored in the memory.

The system consists of at least one device on which both the service provider and service receiver interact. Of course, two systems transferring information back and forth may simplify the use of the present invention. The service provider could choose a question, which would be transmitted to the service receiver's device and when the service receiver answers, the response would be transmitted back to the service provider.

The program storage can be in the form of Read Only Memory (ROM), a hard drive, CD-ROM, DVD, flash memory, or other storage means known to those having skill in the art. The display device may include those devices described above, or other display devices known to those having skill in the art. There are many input devices that may be used in the present invention as known by one having ordinary skill in the art, including, but not limited to, a touch screen, keyboard, stylus, scanning device, computer mouse, voice to text software, etc.

As described above, communications between the device described in the present invention and other systems can be accomplished in many ways as known by one having ordinary skill in the art, including, but not limited to, a dial up MODEM, an RS232 serial port, a parallel port, a connection using Wi-Fi, the IEEE wireless standard (802.11b, 802.11a, 802.11g, etc.), a USB interface, other wireless communications including Bluetooth and 3G, through various Internet connections, etc.

### BRIEF DESCRIPTION OF THE DRAWINGS

FIG. 1 is a block diagram of the software architecture for the main routine in one embodiment of the present invention.

FIG. 2 is a screen print of the language query according to the present invention.

FIG. 3 is a screen print of the language statement according to the present invention.

FIG. 4 is a screen print of the identity query according to the present invention.

FIG. 5 is a screen print of the routine/urgent query according to the present invention.

FIG. 6 is a screen print of the emergency contacts query according to the present invention.

FIG. 7 is a block diagram of the software architecture for the start up routine according to the present invention.

FIGS. 8-18 are screen shots of a presently preferred embodiment of the device and method according to the present invention.

### DESCRIPTION OF THE PREFERRED EMBODIMENT

The present invention describes a service provider/service receiver translation apparatus, system and method, utilizing predefined questions, translated and stored in a device. Although there are numerous settings in which a set of predefined questions or user information can be translated and stored for communications between two people that do not speak the same language, the preferred embodiment contemplates a doctor as the service provider and a patient as the service receiver. The present invention can comprise many different devices, such as a personal computer, a Tablet PC, PDA, cell phone, mini-computer, etc. However, the preferred embodiment of the present invention is a Tablet PC or Personal Digital Assistant (PDA) type device. Such a device, which is well known to one having ordinary skill in the art, may be portable and battery powered, or stationary, with a touch screen for data input and/or other suitable input mechanisms. Many of the existing Tablet PCs are manufactured with integrated speakers and microphones, along with the software and hardware for wireless and wired transmission of information. The device can also store a program having the translation features of the present invention. In the preferred embodiment two PDA's (or Tablet PCs) are used so that the doctor and the patient can view or listen to the translated communication at the same time without one looking over the others shoulder.

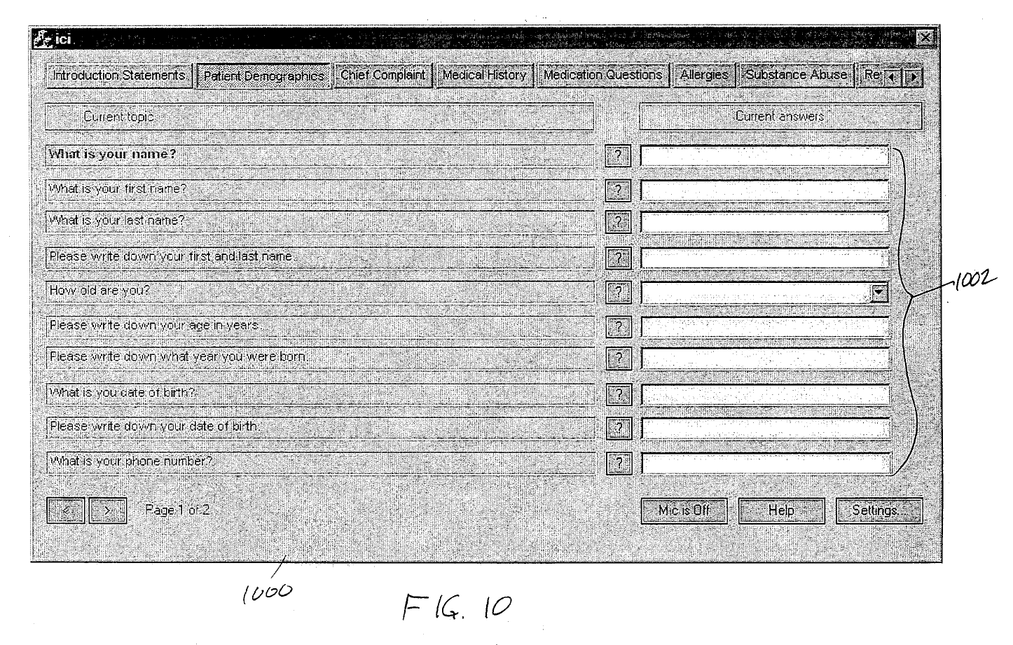

In the health care industry model, pre-translated questions are stored for collecting information from the patient, including the language that the patient understands; personal data (identity, address, emergency contacts, insurance information, primary care provider, etc.); medical history (past medical, past surgical, childhood illnesses, medications, family history, occupation, travel, etc.); and a series of branched question trees to assist the medical staff in collecting information from the patient. (See Table 1 below and FIGS. 8-18 for examples of the pre-translated questions and statements.) These questions are translated and presented to the patient on the screen in text form and the same question or phrase can be played audibly via a speaker or headphones. Although the preferred embodiment utilizes questions and statements that are also stored in their translated form, an alternate embodiment contemplates software that translates the questions in real time, or via a network with an interpreter. The patient can respond to the question by shaking or nodding their head yes/no, or by touching the offered answer choices on the screen or keying an icon or keypad/keyboard; the text for which has been translated to their native language. It will be understood that some questions will result in answers, which by their nature are not yes/no answers but rather qualitative or quantitative. The data collected from a patient will be stored in memory and can be downloaded (or uploaded) to a swipe card or smart card for future use, i.e., the next time the patient visits the doctor, or in case of an emergency when the patient cannot communicate. This memory storage method creates an electronic patient record for future use.

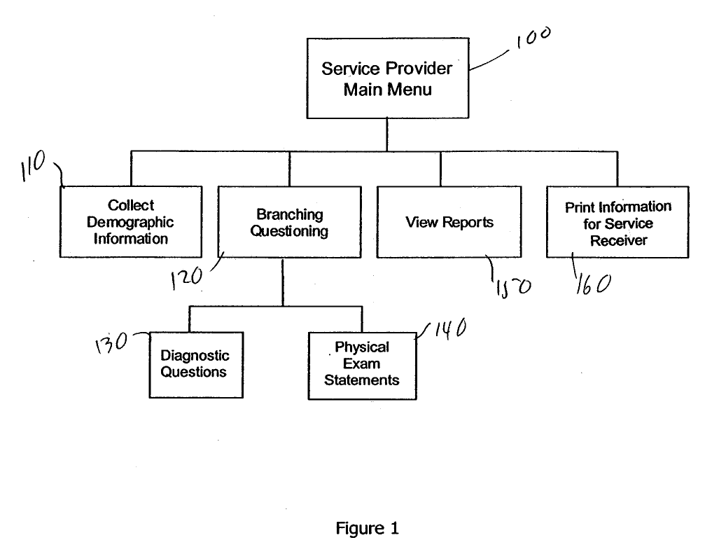

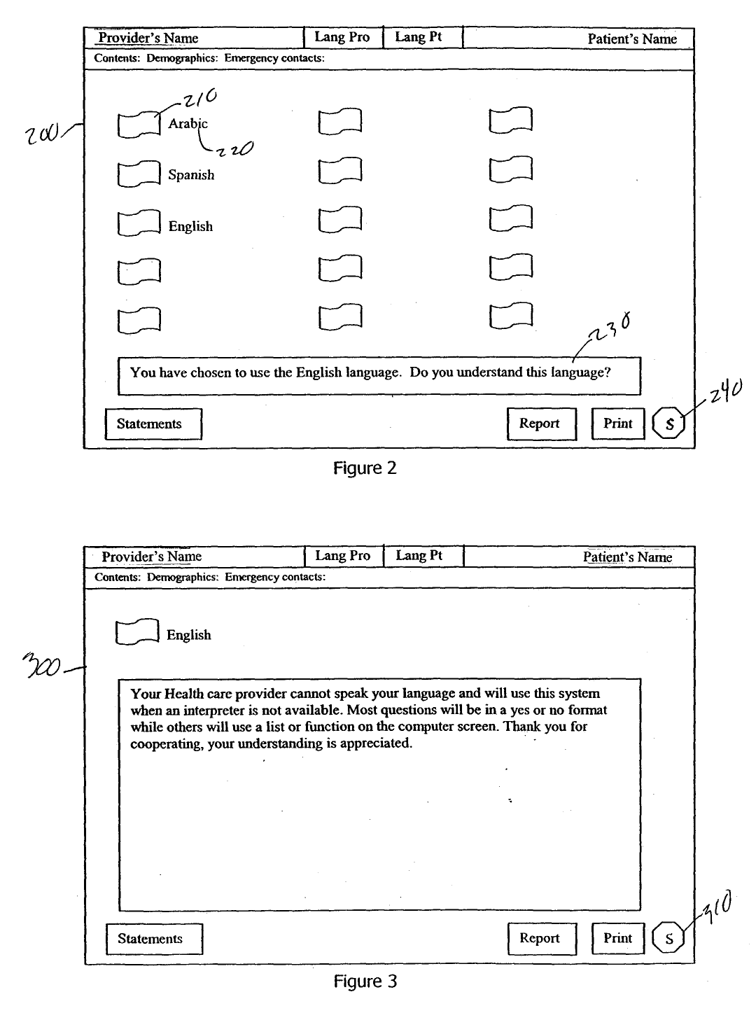

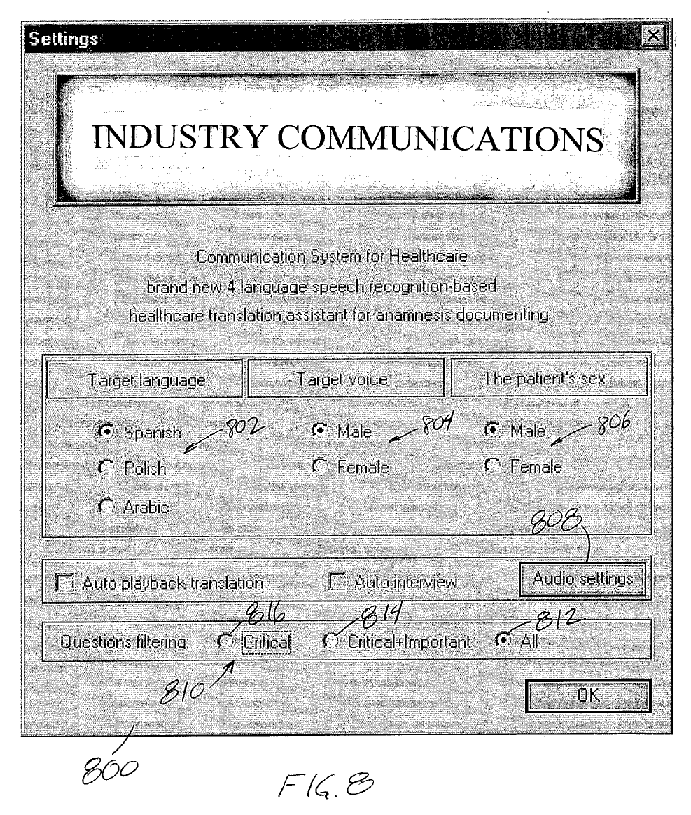

In one embodiment, a health care service provider utilizes the device to administer the translated questions. As shown in FIG. 1, the Service Provider Main Menu 100 allows the service provider to branch into the particular part of the program depending on the objective. If patient information is to be collected, then the service provider can select the Collect Demographic Information (CDI) section 110 (see example at FIG. 6). This may be done in a number of ways (as will all of the provider and receiver selections). For example, the screen may be touched in the proper location indicating the CDI section 110. Also, typing or voice activation may be used to make a selection. These data entry methods are well known to one of ordinary skill in the art. Once the proper language is determined (see FIG. 2), the software will cycle through and obtain all of the patient's demographic information for current and future use.

If the demographic information is already entered, the provider may enter the Branching Questions routine 120 using the selection methods described above. Entering this routine provides another query to the provider: whether diagnostic questions 130 or physical examination questions or statements 140 should be asked of the patient. Once the provider chooses a routine (130, 140), the correct questions will be asked in the proper language. The Provider further has the capability to view reports or print information for the patient. Each of these routines may be selected at the proper time.

Other options provided by the device include the viewing of one or more reports 150. The reports may include the service receiver's personal information, medical history, and optionally results based on the diagnostic questions and/or physical exam statements. Also, the device may provide an option to print a report from the report function 150 and print information for the service receiver, which may be in a printed hard copy version or an electronic version, such as, but not limited to a computer writable/readable smart card.

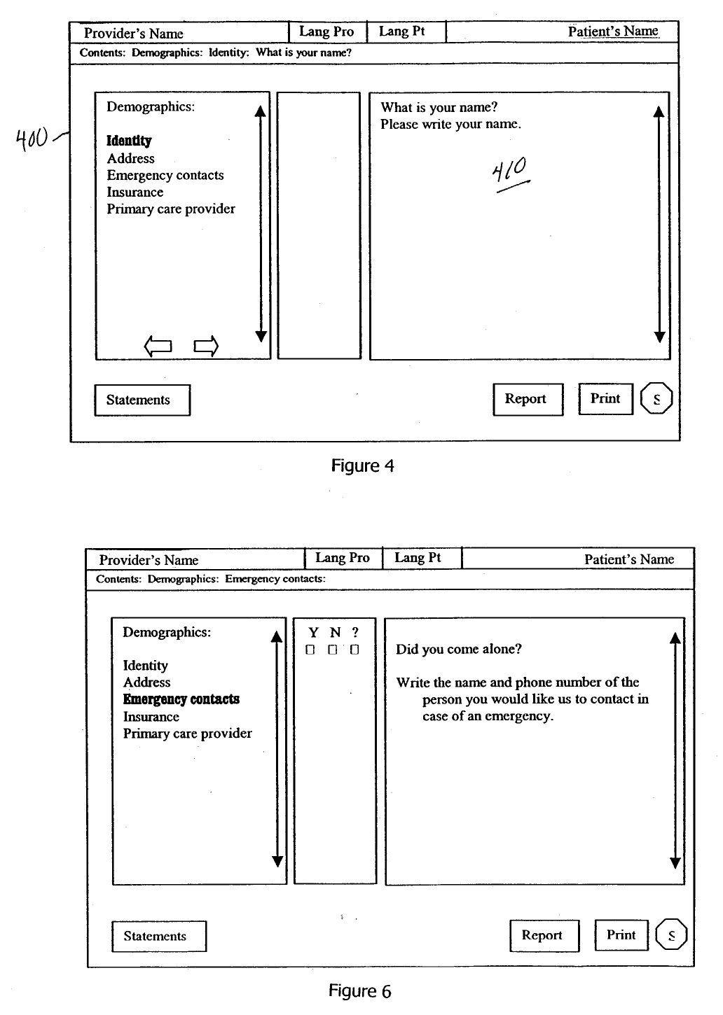

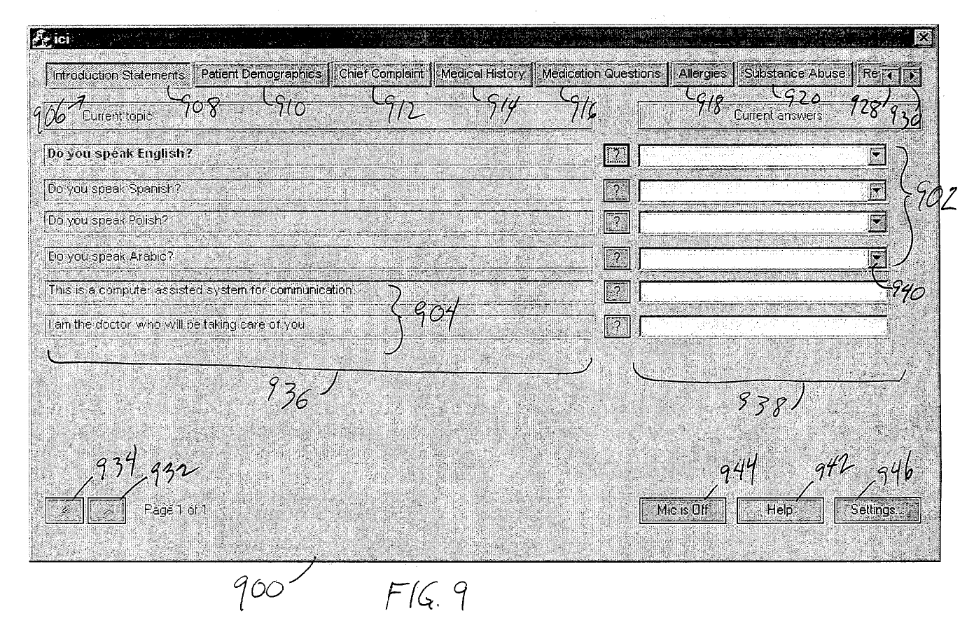

As described above, and shown in FIG. 2, the Collect Demographic Information option 110 is used to establish the patient's native language 200 and collect other personal information, including insurance, emergency contact, and primary physician information. At this time, as shown in FIG. 3, the device will inform the patient that the system is being used by their health care professional to communicate with them in their language 300. Although FIG. 3 shows the “language” information in English, the actual statement will be one or both of a screen display and an audible message played through a speaker of the device 310, in the language understood by the patient. Of course, in emergency situations any or this entire introduction can be bypassed by the health care professional (see also FIG. 7).

Establishing the patient's understood language can be further simplified by presenting the patient with a list of all of the languages supported by the system, and displaying each languages National flag icon 210 as seen in FIG. 2, along with the name of their language 220 next to it. When the patient chooses a language they will be asked if they understand that language in both text and speech via a display 230 and speaker 240 respectively. The patient may then be given a choice of three responses: “Yes”, “No”, and “Next Question” displayed on the screen with the text of the question (not shown). If the patient answers “No” or “Next Question,” the system returns them to the previous screen 200.

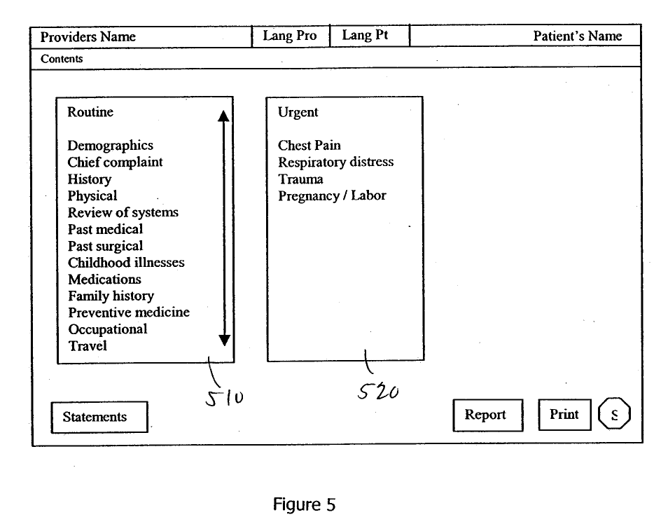

Once the patient's native language is established they are prompted to enter their personal information 400 as shown in FIG. 4. This can be accomplished by allowing the patient to write their name on the touch screen 410 or a touch screen keyboard (not shown) can be displayed. The service provider may elect to enter the data themselves and make use of the recorded files only. Simplification may occur by using two PDA's, or the like, where the doctor controls the questioning process and the patient or service receiver only views the current question, and responds accordingly.

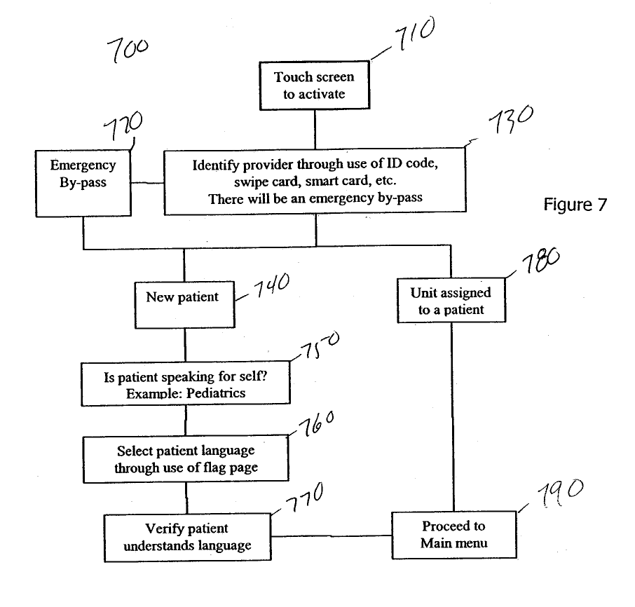

Diagnostic questions may also include questions on the history of present illness and other pertinent medical information. When this option is chosen, the doctor is then presented with the different categories in which question trees are available. The exact design of the question trees and nature of the statements are dependent upon the desired end result of the various procedures supported by the device, i.e., diagnostic procedures, physical exams, informational and educational processes, etc. Emergency categories such as chest pain, respiratory distress, or trauma would be options when the complaint is obvious and time is critical. In non-emergent situations where the medical complaint is not obvious, a series of questions will be available that would give the provider a general idea of why the patient was there. This line of questioning could then be pursued down a logical series of questions familiar to those skilled in the art. FIG. 5 shows the different situations that exist in routine 510 and urgent situations 520. These lists are not limiting and many more questions may need to be asked before a diagnosis is complete, or a physical examination is finished.

The doctor will be able to display a series of questions to the patient in the same “Yes”, “No”, or “Multiple choice” format. The physician will also have the capability to search the database of questions and present a specific question to the patient, if necessary. The physician can view a summary of the patient's answers at any time. The question list will be dynamic in that the health care professional can choose to administer a complete medical history or only essential information in emergency cases as wished. Lines of questioning can be expanded to more specific questions if the provider wished, or if preferred, to skip those areas.

The View Reports section 150 of the main menu shown in FIG. 1 will provide the physician or health care professional the ability to review any information on the patient entered at that time, and to print a succinct summary of the interview process.

The Print Patient Information 160 option will provide a method of allow the physician access to patient information in such areas as suggested treatments, prescription information, and medical procedures that are translated into the patient's native language in both text and audio files. The patient receives this information for future reference and use.

The present invention, in the preferred embodiment, can be placed in a “docking station” to charge the battery or download or upload patient information, similar to the docking stations or cradles on existing Tablet PCs or PDAs. Existing Tablet PCs include models manufactured by Toshiba, such as The Portege 3500 series Tablet PC notebook, or models manufactured by Hewlett Packard such as the Compaq Tablet PC TC1000, etc. Existing PDA's include the numerous models manufactured by Palm Corporation or Handspring Corporation (utilizing the Palm Operating System), or the numerous Pocket PCs using the Microsoft CE Operating System, such as the Compaq iPAQ, the Sony CLIE, the Hewlett Packard Jornada, to name a few. Any suitable software operating system is contemplated. For example, a currently preferred operating system is Windows 2000/XP and a minimum processor requirement is a Pentium Celeron 850 MHz and 128M RAM installed onto a Tablet PC. Further, a proprietary operating system can be developed to run the translation system and method disclosed herein. The present invention contemplates the use of both speech recognition and translation software. It will be understood that one with ordinary skill in the art may utilize any suitable commercially available or proprietary software applications to achieve speech recognition and translation.

The docking stations or cradles for the present invention can be utilized in many ways; however, the preferred embodiment is to have a docking station out side of any room in which a patient would be treated. In this scenario the physician would “dock” the device when leaving the room and the health care professional that comes in next would take the device with the patient if for example the patient had to go to the x-ray room and dock the device in the x-ray room. The x-ray technician will then have all of the patient's information at their fingertips. Another option would be to have a device in each room, similar to a personal computer. Each time the system was updated with patient information, the information would be uploaded to a central server and a health care professional would then be able to download the patient's information onto the device residing in the particular treatment room when needed.

The present invention contemplates use of the device as a stand-alone unit. Preferably, however, the device will be connected to other devices. In this manner, the flexibility and communication advantages are maximized. The other devices may be one or more similar inventive devices or any other suitable electronic devices, such as, for example, other PCs, PDAs, Tablet PCs, servers, printers, storage devices, telematic devices, cellular or mobile phones and instruments, e.g., medical instrumentation, monitors, detectors, sensors, etc. The device may communicate via conventional wiring via wired networks or through any suitable wireless network. It will be understood that wireless networks will be of particular flexibility in that, users (care receivers and care providers) or other users (assistants, record keepers, accounting professionals, medical workers, quality control professionals, transcriptionists, administrators, etc.) may remotely input and receive information, present questions and answers, provide translations, transmit and receive data and other information. This data and information may be transmitted and received in a clinic or hospital setting where there are a number of separate rooms or stations via the inventive devices and also to and from record keeping devices and other connected devices. The data and information may be transmitted to remote locations and devices regardless of location. The operating software, applications and databases may reside on a central server or node that has the capability of providing all of the present invention's functionality to a number of connected workstations or reside at decentralized nodes.

FIG. 7 shows one embodiment of a simplified flow chart 700 to illustrate a process according to the present invention. A touching of a touch screen 710, or a like activation mechanism may activate the device. If the patient is a pre-existing patient, the inputting or recognition of pre-exiting personal and medical history information will permit the system to bypass the initial data input procedure (110, in FIG. 1). In this case, the patient may be assigned a unit 780 and the system proceeds to the main menu where further questioning takes place to assist in the determination of a diagnosis or the process of a physical exam 790.

If the situation is an emergency, a bypass function is activated 720. Selecting the bypass function eliminates many of the data acquisition functions of the system and permits the rapid addressing of the problem. If the patient is a new patient 740, in an emergency a simple line of questioning will streamline the intake process before substantive questioning can take place (790). The simple questions may include whether the patient is speaking for him/herself 750, which would be useful when the patient is a young person or infant. The patient or guardian would select the patient/guardian language 760. The device might request that the patient verify that he/she understands the language being presented by the device 770. When the verification takes place, the device proceeds to the main menu 790 where further questioning takes place to assist in the determination of a diagnosis or the process of a physical exam.

It will be understood that each of the above and following steps may be undertaken by a number of methods. The patient or a companion or guardian, a caregiver, a nurse or assistant, may make selections or input information into the device by using, for example, voice, keypad, touch-sensitive screen, memory card or the like.

FIGS. 8-20 illustrate an embodiment of screen shots of the device to show, in part, the workflow routine and the architecture of the process of the present invention. A first screen 800 as seen in FIG. 8 displays initial input information requirements, namely, the language input selections 802, the sex of the target voice 804 and the patient's sex 806. A button is provided to adjust the audio settings 808. Another feature of the first screen 800 is a selection 810 directed to the urgency of the situation. The urgency selection 810 may be broken down into a non-urgent option 812, a critical and important option 814, and a critical option 816. Selecting one of the urgency selection 810 menus will determine which subsequent input screens are offered. Selecting the critical 816 option, causes the workflow and screens presented so as to eliminate many of the standard input screens and proceeds directly to medical and diagnostic questions directed to resolve a critical situation. Selecting the critical and important option 814 causes the workflow to present screens directed to important and critical questions. This option may be useful in a situation where the patient has made a previous visit and medical history information has already been entered into the system. The all option 812 may be selected where a patient is being entered into the system for the first time and personal and historical information may be entered.

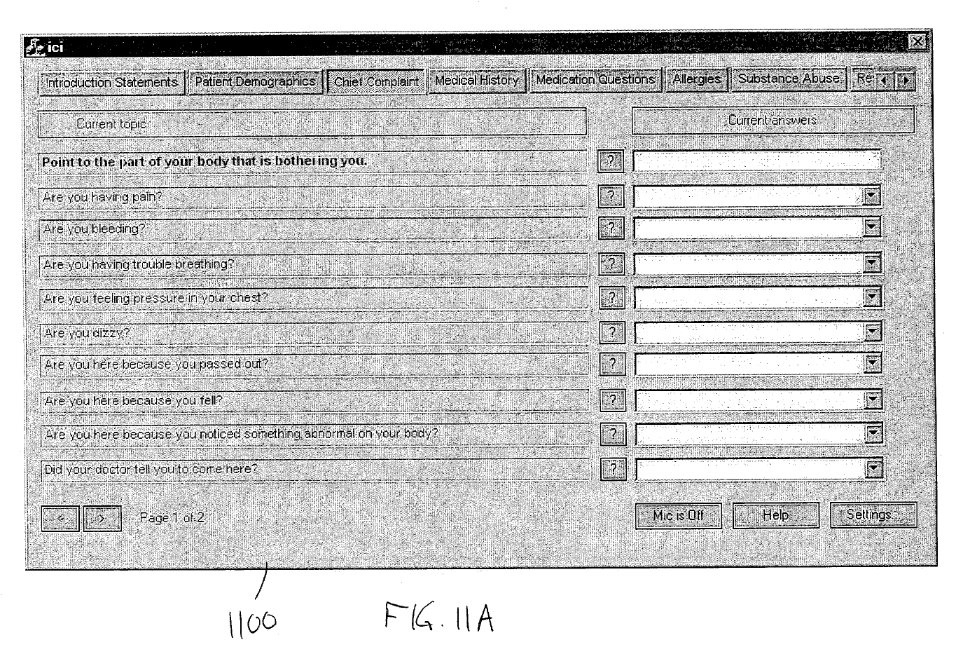

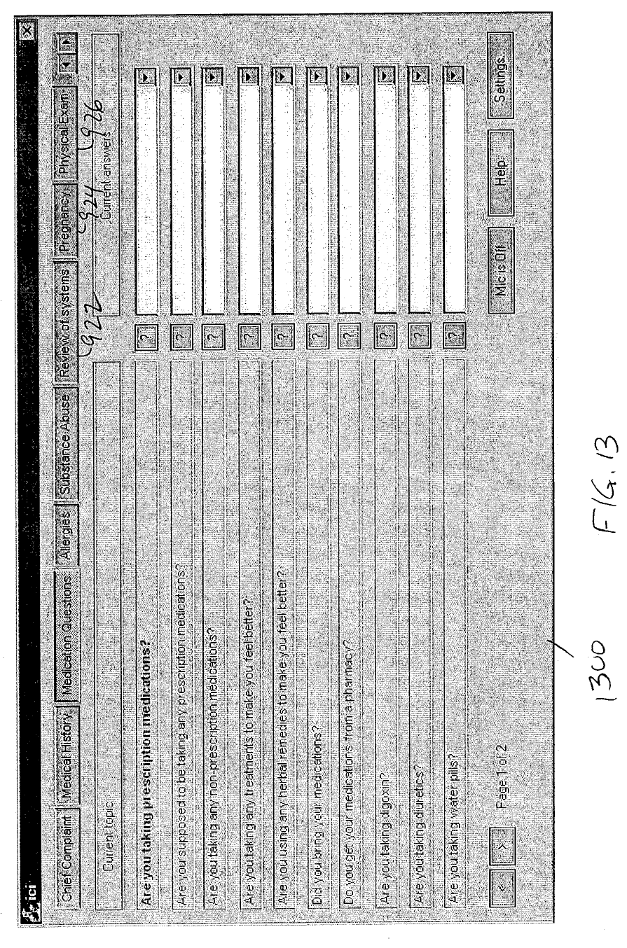

An Introduction Statements screen 900 as seen in FIG. 9 includes selections directed to confirming the language of the care receiver 902. Also, statements 904 may be provided to the patients, which are general and informational in nature, typical of early patient interview situations. These may be text and audio provided in the patient language. Common to all or most of the subsequent screens is a taskbar 906, which includes all of the modules, subroutines or subareas of the application. These may include Introduction Statements 908, Patient Demographics 910, Chief Complaint 912, Medical History 914, Medication Questions 916, Allergies 918, Substance Abuse 920, Review of systems 922, Pregnancy 924 and Physical Exam 926 as seen in FIGS. 9 and 13. Those skilled in the art will recognize that other areas of questions and statements may be provided depending on the needs of the user and the situation.

The screen 900 may also be provided with forward and back selections 928, 930 to facilitate access to other screens. The screen 900 may be provided with forward and back selections 932, 934 to facilitate access to pages or other screens. Each screen is divided generally into a topic area 936 and an answer area 938. The topic area 936 presents questions or statements {in English or another language). The answer area 938 includes yes/no selections as a drop down menu 940 or other suitable form. Each screen will also include a help selection 942, an indicator 944 for showing whether a microphone is enabled or disabled, and a settings selection 946 for returning to the initial screen 800.

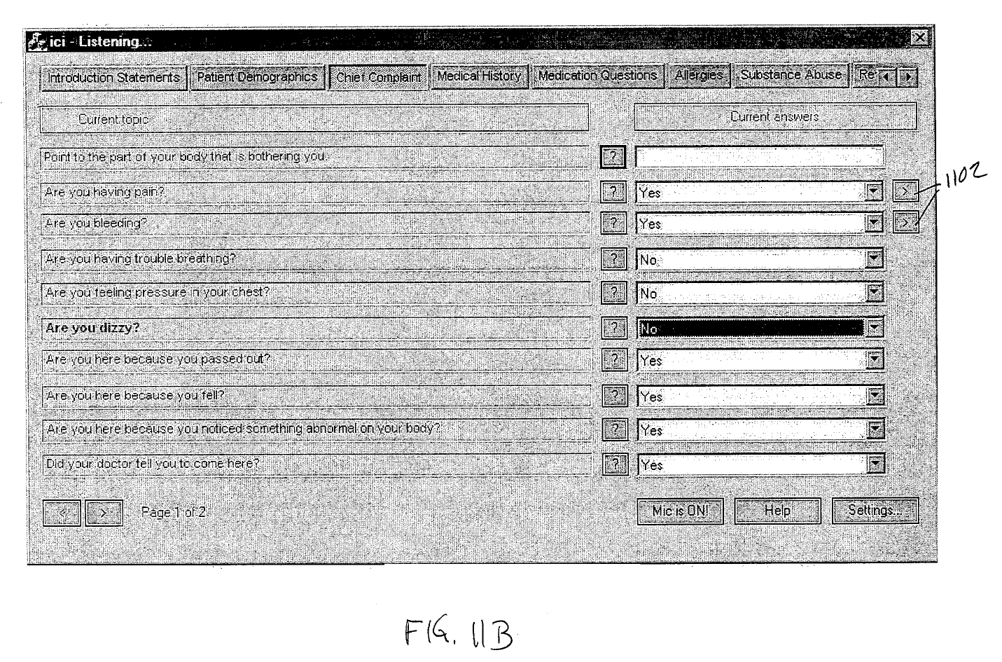

FIG. 10 illustrates a Patient Demographics screen 1000. The topic area includes questions and statements directed to the patient demographics such as, for example, name, age, address, phone and other information. Fields 1002 are provided to permit the recording of this information. These fields are present on at least most of the subsequent screens to record answers, statements and other information.

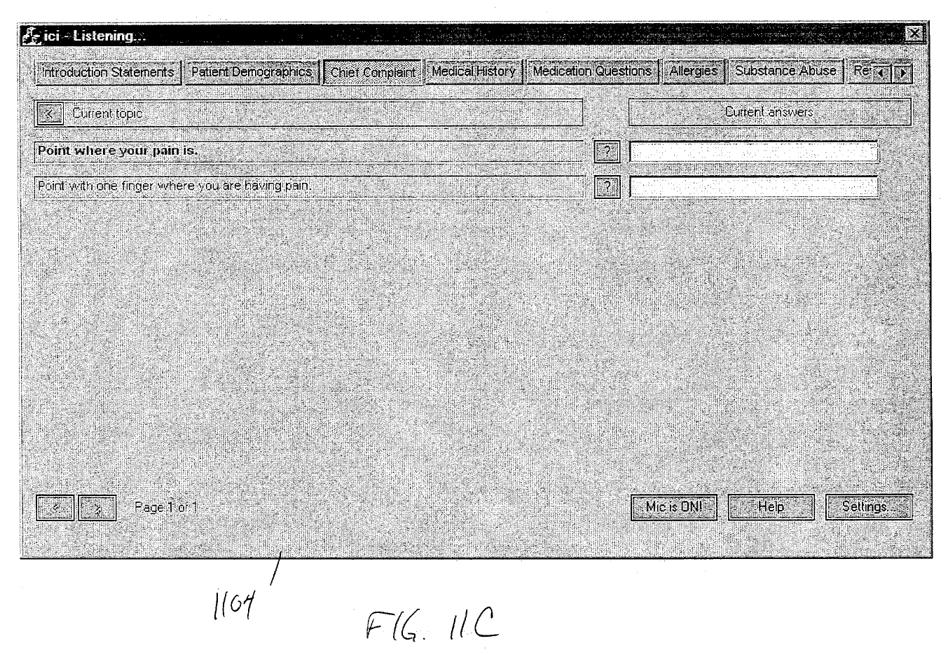

FIGS. 11A and 11B illustrate a Chief Complaint screen 1100. The topic area includes questions and statements directed to communicating the perceived problem that prompted the patient visit such as, for example, the presence of pain, breathing problems, pressure, dizziness, and other related issues. A feature of the device and process of the present invention is that screens or the questions and information displayed in the screens may be nested or associated according to logical medical and record keeping processes. In other words, it may be useful, in response to an affirmative answer in the Chief Complaint screen 1100, a “Next” selection 1102 may be provided, which indicates the presence of a subsequent screen. Therefore, as in the example given in FIGS. 11B, in response to an affirmative answer to the question, “Are you having pain?” the selection of displayed button 1102 will display screen 11C. FIGS. 1C illustrates the resultant screen 1104, where more detail is elicited regarding the position of the pain, and optionally, in subsequent screens the nature of the pain and other needed details regarding the pain or instructions to the patient, understood by one having ordinary skill in the art in the art. As such, the device and method of the present invention is capable of providing diagnostic support, communication facilitation, record keeping and report generating. The same scheme may be applied to all or some of the subareas/modules of the present invention.

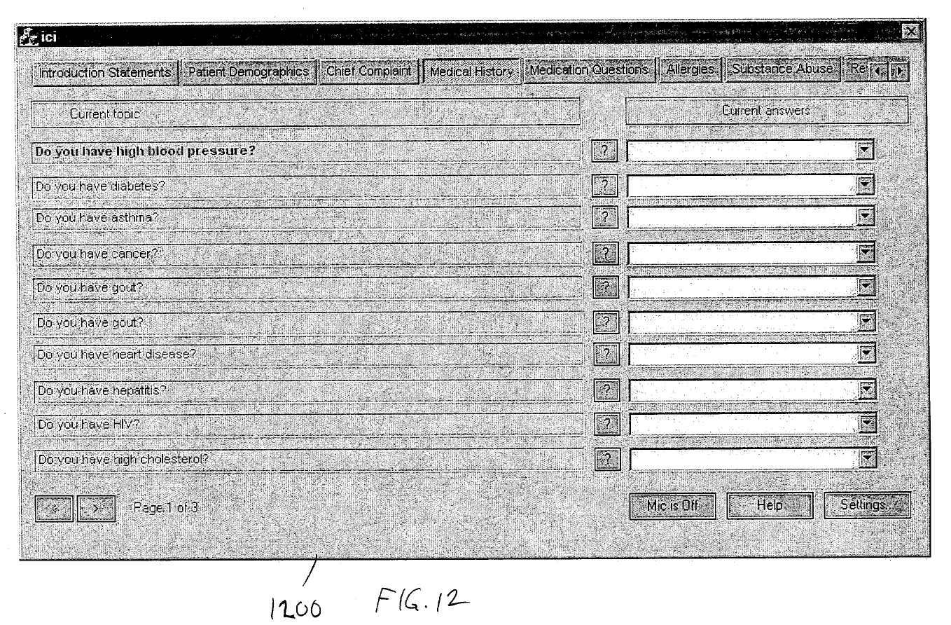

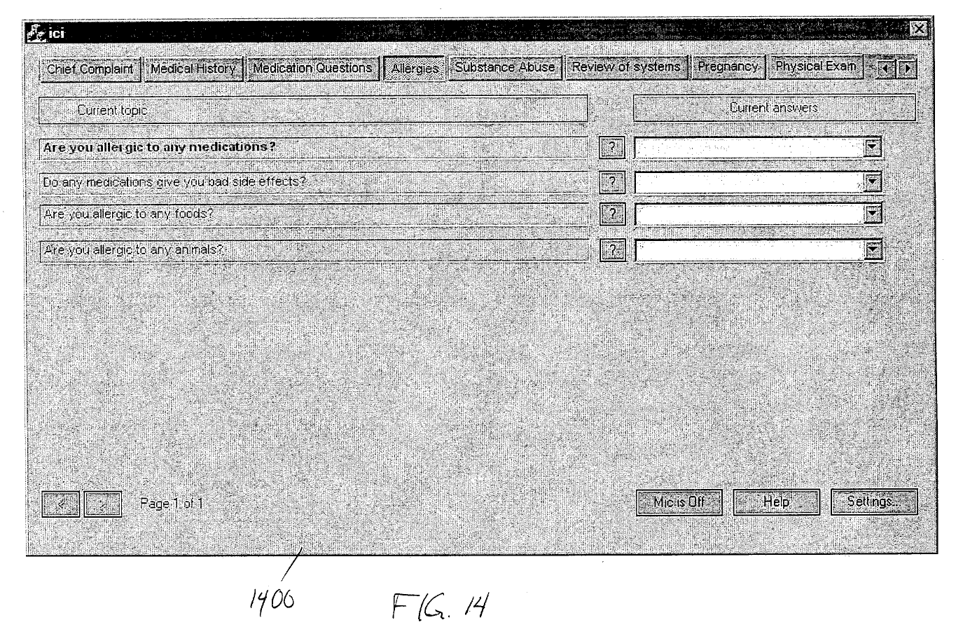

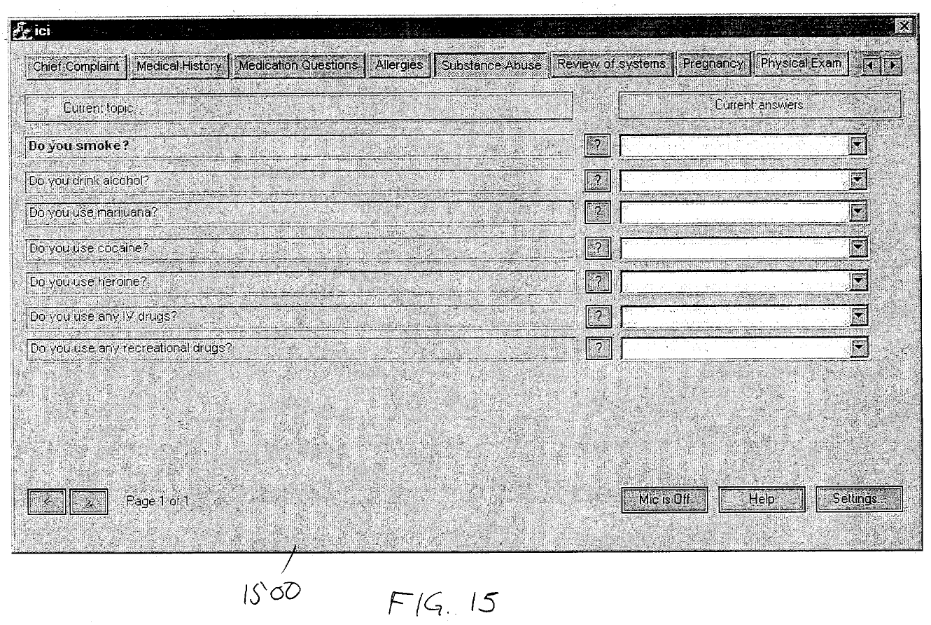

The Medical History screen 1200 as seen in FIG. 12 includes questions and statements directed to the patient medical history. For example, questions directed to the presence of high blood pressure, diabetes, asthma, cancer, gout, heart disease and infectious disease, high cholesterol and other conditions might be presented. The Medical Questions screen 1300 as seen in FIG. 13 includes questions and statements directed to the patient current medical condition. For example, questions directed to the patient's prescription medication are presented. The Allergies screen 1400 as seen in FIG. 14 presents questions related to allergies, such as allergies and side effects related to medicine, foods, plants and animals. The Substance Abuse screen 1500 as seen in FIG. 15 presents questions related to the abuse of various substances such as cigarettes, alcohol, marijuana, cocaine, heroin and other materials.

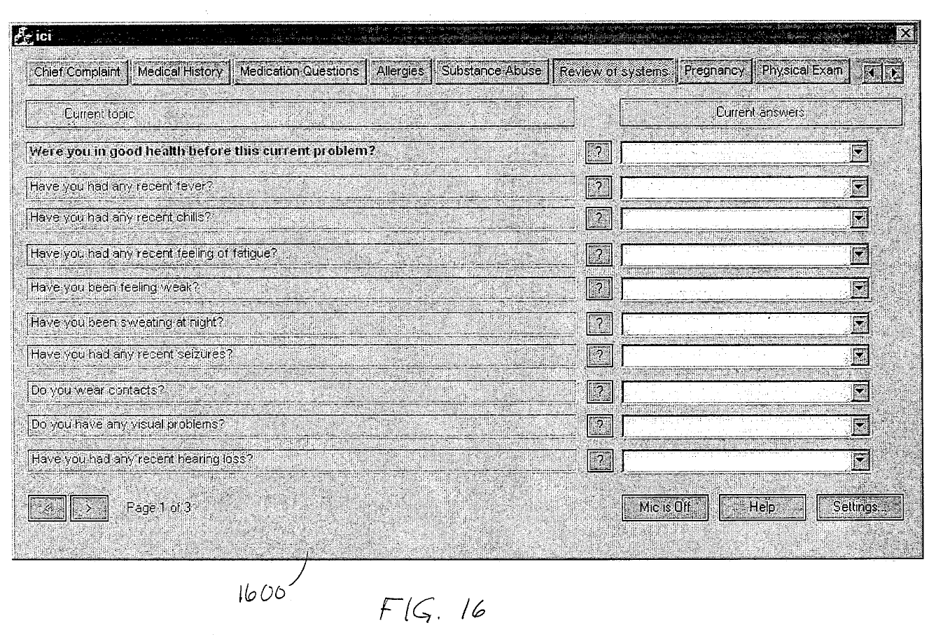

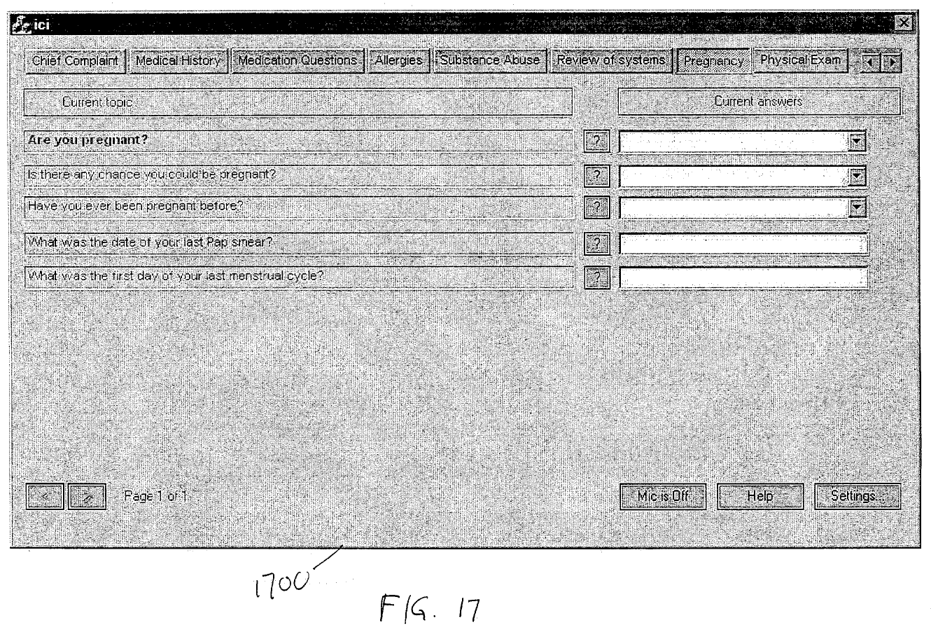

The Review of Systems screen 1600 as seen in FIG. 16 presents questions related to the basic biological systems. Some questions presented are, for example, related to basic health, the presence of fever, chills, fatigue, weakness, night sweats, seizures, visual problems, hearing loss, etc. The Pregnancy screen 1700 as seen in FIG. 17 presents questions related to pregnancy. These questions may include whether or not the patient is pregnant, the possibility of pregnancy, history of pregnancy, date of last pap smear, and the first day of the patient's last menstrual cycle, for example.

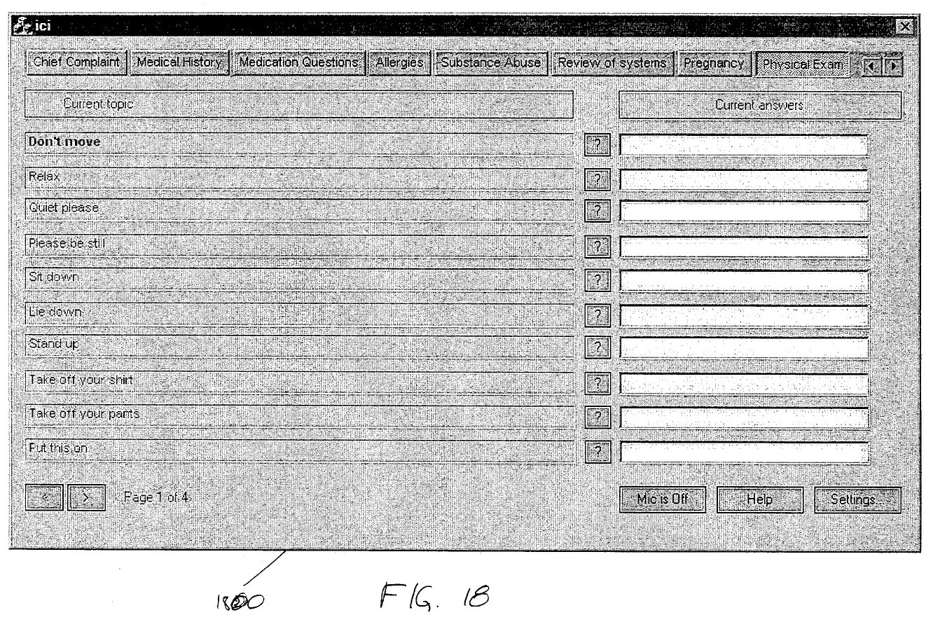

A list of sample questions, statements and instructions are presented on the Physical Exam screen 1800 as seen in FIG. 18. These instructions are intended to assist the care provider by instructing the care receiver so as to facilitate the exam. The instructions include statements such as, “relax,” “sit down,” “put this on,” and so on. There are many other questions or statements that can be included. Further, depending on the intended use or application of the device, for example, the type of industry, different questions and statements can be stored in their translated language for use in necessary situations.

Table 1 illustrates an example in text form of a method and set of selectable screens and fields according to the present invention applicable to the device of the present invention as shown in FIGS. 8-18, above.

TABLE 1

| 1 -1 Introduction Statements | | |
|---|---|---|
| 1.1 83 Do you speak English? | 1.1.1 -1 Yes | 1.1.2 -1 No |
| 1.2 85 Do you speak Spanish? | 1.2.1 -1 Yes | 1.2.2 -1 No |
| 1.3 84 Do you speak Polish? | 1.3.1 -1 Yes | 1.3.2 -1 No |
| 1.4 82 Do you speak Arabic? | 1.4.1 -1 Yes | 1.4.2 -1 No |
| 1.5 187 This is a computer assisted system for | 1.5.1 -1 . . . | |
| communication. | | |
| 1.6 147 I am the doctor who will be taking care of | 1.6.1 -1 . . . | |
| you | | |
| 2 -1 Patient Demographics | | |
| 2.2 197 What is your first name? | 2.2.1 -1 . . . | |
| 2.3 198 What is your last name? | 2.3.1 -1 . . . | |
| 2.4 170 Please write down your first and last name. | 2.4.1 -1 . . . | |
| 2.5 146 How old are you? | 2.5.1 -1 Yes | 2.5.2 -1 No |
| 2.6 167 Please write down your age in years. | 2.6.1 -1 . . . | |
| 2.7 166 Please write down what year you were born. | 2.7.1 -1 . . . | |
| 2.8 196 What is you date of birth? | 2.8.1 -1 . . . | |
| 2.9 168 Please write down your date of birth. | 2.9.1 -1 . . . | |
| 2.10 200 What is your phone number? | 2.10.1 -1 . . . | |
| 2.11 171 Please write down your phone number. | 2.11.1 -1 . . . | |
| 3 -1 Chief Complaint | | |
| 3.1 172 Point to the part of your body that is | 3.1.1 -1 . . . | |
| bothering you. | | |
| 3.2 22 Are you having pain? | 3.2.1 -1 Yes | |
| 3.2.1.1 174 Point where your pain is. | 3.2.1.1.1 -1 . . . | |
| 3.2.1.2 175 Point with one finger where you are | 3.2.1.2.1 -1 . . . | 3.2.2 -1 No |
| having pain. | | |
| 3.3 15 Are you bleeding? | 3.3.1 -1 Yes | |
| 3.3.1.1 173 Point to where you are bleeding. | 3.3.1.1.1 -1 . . . | 3.3.2 -1 No |
| 3.4 23 Are you having trouble breathing? | 3.4.1 -1 Yes | 3.4.2 -1 No |
| 3.5 18 Are you feeling pressure in your chest? | 3.5.1 -1 Yes | 3.5.2 -1 No |
| 3.6 17 Are you dizzy? | 3.6.1 -1 Yes | 3.6.2 -1 No |
| 3.7 26 Are you here because you passed out? | 3.7.1 -1 Yes | 3.7.2 -1 No |
| 3.8 24 Are you here because you fell? | 3.8.1 -1 Yes | 3.8.2 -1 No |
| 3.9 25 Are you here because you noticed something | 3.9.1 -1 Yes | 3.9.2 -1 No |
| abnormal on your body? | | |
| 3.10 58 Did your doctor tell you to come here? | 3.10.1 -1 Yes | 3.10.2 -1 No |
| 3.11 19 Are you feeling sick? | 3.11.1 -1 Yes | 3.11.2 -1 No |
| 3.12 80 Do you need a refill on medication? | 3.12.1 -1 Yes | 3.12.2 -1 No |
| 3.13 27 Are you here for a general check-up? | 3.13.1 -1 Yes | 3.13.2 -1 No |
| 3.14 86 Do you think you might be pregnant? | 3.14.1 -1 Yes | 3.14.2 -1 No |
| 3.15 29 Are you pregnant? | 3.15.1 -1 Yes | 3.15.2 -1 No |
| 3.16 192 Were you attacked or assaulted in any | 3.16.1 -1 Yes | 3.16.2 -1 No |
| way? | | |
| 3.17 53 Did you have an accident? | 3.17.1 -1 Yes | 3.17.2 -1 No |
| 3.18 52 Did you do something to hurt yourself? | 3.18.1 -1 Yes | 3.18.2 -1 No |
| 3.19 87 Do you think you might hurt yourself? | 3.19.1 -1 Yes | 3.19.2 -1 No |
| 3.20 158 Is someone trying to hurt you? | 3.20.1 -1 Yes | 3.20.2 -1 No |
| 4 -1 Medical History | | |
| 4.1 73 Do you have high blood pressure? | 4.1.1 -1 Yes | 4.1.2 -1 No |
| 4.2 69 Do you have diabetes? | 4.2.1 -1 Yes | 4.2.2 -1 No |
| 4.3 67 Do you have asthma? | 4.3.1 -1 Yes | 4.3.2 -1 No |
| 4.4 68 Do you have cancer? | 4.4.1 -1 Yes | 4.4.2 -1 No |
| 4.5 70 Do you have gout? | 4.5.1 -1 Yes | 4.5.2 -1 No |
| 4.6 71 Do you have heart disease? | 4.6.1 -1 Yes | 4.6.2 -1 No |
| 4.7 72 Do you have hepatitis? | 4.7.1 -1 Yes | 4.7.2 -1 No |
| 4.8 75 Do you have HIV? | 4.8.1 -1 Yes | 4.8.2 -1 No |
| 4.9 74 Do you have high cholesterol? | 4.9.1 -1 Yes | 4.9.2 -1 No |
| 4.10 76 Do you have migraines? | 4.10.1 -1 Yes | 4.10.2 -1 No |
| 4.11 79 Do you have tuberculosis? | 4.11.1 -1 Yes | 4.11.2 -1 No |
| 4.12 78 Do you have sickle cell anemia? | 4.12.1 -1 Yes | 4.12.2 -1 No |
| 4.13 65 Do you have a stomach ulcer? | 4.13.1 -1 Yes | 4.13.2 -1 No |
| 4.14 64 Do you have a sexually transmitted disease? | 4.14.1 -1 Yes | 4.14.2 -1 No |
| 4.15 16 Are you depressed? | 4.15.1 -1 Yes | 4.15.2 -1 No |
| 4.16 112 Have you ever had a heart attack? | 4.16.1 -1 Yes | 4.16.2 -1 No |
| 4.17 113 Have you ever had a heart problem? | 4.17.1 -1 Yes | 4.17.2 -1 No |
| 4.18 117 Have you ever had an angiogram? | 4.18.1 -1 Yes | 4.18.2 -1 No |
| 4.19 116 Have you ever had a stroke? | 4.19.1 -1 Yes | 4.19.2 -1 No |
| 4.20 119 Have you ever passed out? | 4.20.1 -1 Yes | 4.20.2 -1 No |
| 4.21 109 Have you ever fainted? | 4.21.1 -1 Yes | 4.21.2 -1 No |
| 4.22 118 Have you ever had surgery? | 4.22.1 -1 Yes | 4.22.2 -1 No |
| 4.23 104 Have you ever be admitted to a hospital | 4.23.1 -1 Yes | 4.23.2 -1 No |
| before? | | |
| 4.24 105 Have you ever been in a serious accident? | 4.24.1 -1 Yes | 4.24.2 -1 No |
| 4.25 110 Have you ever had a blood transfusion? | 4.25.1 -1 Yes | 4.25.2 -1 No |
| 4.26 107 Have you ever been treated for a mental | 4.26.1 -1 Yes | 4.26.2 -1 No |
| disease? | | |
| 4.27 108 Have you ever been treated for cancer? | 4.27.1 -1 Yes | 4.27.2 -1 No |
| 5 -1 Medication Questions | | |
| 5.1 43 Are you taking prescription medications? | 5.1.1 -1 Yes | 5.1.2 -1 No |
| 5.2 30 Are you supposed to be taking any | 5.2.1 -1 Yes | 5.2.2 -1 No |
| prescription medications? | | |
| 5.3 32 Are you taking any non-prescription | 5.3.1 -1 Yes | 5.3.2 -1 No |
| medications? | | |
| 5.4 33 Are you taking any treatments to make you | 5.4.1 -1 Yes | |
| feel better? | | |
| 5.4.1.1 95 Does your doctor know about these | 5.4.1.1.1 -1 Yes | 5.4.1.1.2 -1 No |
| treatments? | | 5.4.2 -1 No |
| 5.5 46 Are you using any herbal remedies to make | 5.5.1 -1 Yes | 5.5.2 -1 No |
| you feel better? | | |
| 5.6 51 Did you bring your medications? | 5.6.1 -1 Yes | 5.6.2 -1 No |
| 5.7 63 Do you get your medications from a | 5.7.1 -1 Yes | |
| pharmacy? | | |
| 5.7.1.1 194 What is the name of the pharmacy where | 5.7.1.1.1 -1 . . . | |
| you get your medications from? | | |
| 5.7.1.2 195 What is the phone number of the | 5.7.1.2.1 -1 . . . | 5.7.2 -1 No |
| pharmacy? | | |
| 5.8 37 Are you taking digoxin? | 5.8.1 -1 Yes | 5.8.2 -1 No |
| 5.9 38 Are you taking diuretics? | 5.9.1 -1 Yes | 5.9.2 -1 No |
| 5.10 45 Are you taking water pills? | 5.10.1 -1 Yes | 5.10.2 -1 No |
| 5.11 34 Are you taking aspirin? | 5.11.1 -1 Yes | 5.11.2 -1 No |
| 5.12 36 Are you taking coumadin? | 5.12.1 -1 Yes | 5.12.2 -1 No |
| 5.13 41 Are you taking medications for your blood | 5.13.1 -1 Yes | 5.13.2 -1 No |
| pressure? | | |
| 5.14 35 Are you taking blood thinners? | 5.14.1 -1 Yes | 5.14.2 -1 No |
| 5.15 31 Are you taking antibiotics? | 5.15.1 -1 Yes | 5.15.2 -1 No |
| 5.16 44 Are you taking Viagra? | 5.16.1 -1 Yes | 5.16.2 -1 No |
| 5.17 42 Are you taking plavix? | 5.17.1 -1 Yes | 5.17.2 -1 No |
| 5.18 40 Are you taking medication to treat high | 5.18.1 -1 Yes | 5.18.2 -1 No |
| cholesterol? | | |
| 6 -1 Allergies | | |
| 6.1 3 Are you allergic to any medications? | 6.1.1 -1 Yes | |
| 6.1.1.1 11 Are you allergic to penicillin? | 6.1.1.1.1 -1 Yes | 6.1.1.1.2 -1 No |
| 6.1.1.2 14 Are you allergic to sulfa drugs? | 6.1.1.2.1 -1 Yes | 6.1.1.2.2 -1 No |
| 6.1.1.3 4 Are you allergic to aspirin? | 6.1.1.3.1 -1 Yes | 6.1.1.3.2 -1 No |
| 6.1.1.4 13 Are you allergic to sedatives? | 6.1.1.4.1 -1 Yes | 6.1.1.4.2 -1 No |
| 6.1.1.5 5 Are you allergic to codeine? | 6.1.1.5.1 -1 Yes | 6.1.1.5.2 -1 No |
| 6.1.1.6 7 Are you allergic to morphine? | 6.1.1.6.1 -1 Yes | 6.1.1.6.2 -1 No |
| 6.1.1.7 9 Are you allergic to pain medication? | 6.1.1.7.1 -1 Yes | 6.1.1.7.2 -1 No |
| 6.1.1.8 6 Are you allergic to coumadin? | 6.1.1.8.1 -1 Yes | 6.1.1.8.2 -1 No |
| | | 6.1.2 -1 No |
| 6.2 59 Do any medications give you bad side | 6.2.1 -1 Yes | |
| effects? | | |
| 6.2.1.1 165 Please write down the name of the | 6.2.1.1.1 -1 . . . | |
| medication that you are allergic to. | | |
| 6.2.1.2 57 Did you have trouble breathing because of | 6.2.1.2.1 -1 Yes | 6.2.1.2.2 -1 No |
| the allergic reaction? | | |
| 6.2.1.3 50 Did you break out into a rash because of | 6.2.1.3.1 -1 Yes | 6.2.1.3.2 -1 No |
| the allergic reaction? | | 6.2.2 -1 No |
| 6.3 2 Are you allergic to any foods? | 6.3.1 -1 Yes | |
| 6.3.1.1 12 Are you allergic to seafood? | 6.3.1.1.1 -1 Yes | 6.3.1.1.2 -1 No |
| 6.3.1.2 10 Are you allergic to peanuts? | 6.3.1.2.1 -1 Yes | 6.3.1.2.2 -1 No |
| 6.3.1.3 8 Are you allergic to mushrooms? | 6.3.1.3.1 -1 Yes | 6.3.1.3.2 -1 No |
| | | 6.3.2 -1 No |
| 6.4 1 Are you allergic to any animals? | 6.4.1 -1 Yes | 6.4.2 -1 No |
| 7 -1 Substance Abuse | | |
| 7.1 81 Do you smoke? | 7.1.1 -1 Yes | 7.1.2 -1 No |
| 7.1.2.1 143 Have you smoked cigarettes in the past? | 7.1.2.1.1 -1 Yes | 7.1.2.1.2 -1 No |
| 7.2 61 Do you drink alcohol? | 7.2.1 -1 Yes | |
| 7.2.1.1 77 Do you have more than five alcoholic | 7.2.1.1.1 -1 Yes | 7.2.1.1.2 -1 No |
| drinks a day? | | |
| 7.2.1.2 62 Do you drink more than 12 beers a week? | 7.2.1.2.1 -1 Yes | 7.2.1.2.2 -1 No |
| | | 7.2.2 -1 No |
| 7.3 92 Do you use marijuana? | 7.3.1 -1 Yes | 7.3.2 -1 No |
| 7.4 90 Do you use cocaine? | 7.4.1 -1 Yes | 7.4.2 -1 No |
| 7.5 91 Do you use heroin? | 7.5.1 -1 Yes | 7.5.2 -1 No |
| 7.6 88 Do you use any IV drugs? | 7.6.1 -1 Yes | 7.6.2 -1 No |
| 7.7 89 Do you use any recreational drugs? | 7.7.1 -1 Yes | 7.7.2 -1 No |
| 8 -1 Review of systems | | |
| 8.1 193 Were you in good health before this current | 8.1.1 -1 Yes | 8.1.2 -1 No |
| problem? | | |
| 8.2 132 Have you had any recent fever? | 8.2.1 -1 Yes | 8.2.2 -1 No |
| 8.3 126 Have you had any recent chills? | 8.3.1 -1 Yes | 8.3.2 -1 No |
| 8.4 131 Have you had any recent feeling of fatigue? | 8.4.1 -1 Yes | 8.4.2 -1 No |
| 8.5 100 Have you been feeling weak? | 8.5.1 -1 Yes | 8.5.2 -1 No |
| 8.6 102 Have you been sweating at night? | 8.6.1 -1 Yes | 8.6.2 -1 No |
| 8.7 136 Have you had any recent seizures? | 8.7.1 -1 Yes | 8.7.2 -1 No |
| 8.8 94 Do you wear contacts? | 8.8.1 -1 Yes | 8.8.2 -1 No |
| 8.9 66 Do you have any visual problems? | 8.9.1 -1 Yes | 8.9.2 -1 No |
| 8.10 133 Have you had any recent hearing loss? | 8.10.1 -1 Yes | 8.10.2 -1 No |
| 8.11 122 Have you had any recent abnormal bruising | 8.11.1 -1 Yes | 8.11.2 -1 No |
| or bleeding? | | |
| 8.12 125 Have you had any recent change in your | 8.12.1 -1 Yes | 8.12.2 -1 No |
| voice? | | |
| 8.13 137 Have you had any recent sores in your | 8.13.1 -1 Yes | 8.13.2 -1 No |
| mouth? | | |
| 8.14 127 Have you had any recent colds or | 8.14.1 -1 Yes | 8.14.2 -1 No |
| respiratory infections? | | |
| 8.15 129 Have you had any recent cough? | 8.15.1 -1 Yes | 8.15.2 -1 No |
| 8.16 99 Have you been coughing up any sputum? | 8.16.1 -1 Yes | 8.16.2 -1 No |
| 8.17 93 Do you wake up at night with difficulty | 8.17.1 -1 Yes | 8.17.2 -1 No |
| breathing? | | |
| 8.18 134 Have you had any recent heart palpitations? | 8.18.1 -1 Yes | 8.18.2 -1 No |
| 8.19 138 Have you had any recent swelling of | 8.19.1 -1 Yes | 8.19.2 -1 No |
| particular body parts? | | |
| 8.20 124 Have you had any recent blood in your | 8.20.1 -1 Yes | 8.20.2 -1 No |
| urine? | | |
| 8.21 123 Have you had any recent blood in your | 8.21.1 -1 Yes | 8.21.2 -1 No |
| stools? | | |
| 8.22 130 Have you had any recent diarrhea? | 8.22.1 -1 Yes | 8.22.2 -1 No |
| 8.23 128 Have you had any recent constipation? | 8.23.1 -1 Yes | 8.23.2 -1 No |
| 8.24 135 Have you had any recent pain with | 8.24.1 -1 Yes | 8.24.2 -1 No |
| urination? | | |
| 9 -1 Pregnancy | | |
| 9.1 29 Are you pregnant? | 9.1.1 -1 Yes | |
| 9.1.1.1 145 How many weeks gestation are you | 9.1.1.1.1 -1 Yes | 9.1.1.1.2 -1 No |
| now? | | |
| 9.1.1.2 203 When is your estimated due date? | 9.1.1.2.1 -1 . . . | |
| 9.1.1.3 169 Please write down your estimated due | 9.1.1.3.1 -1 . . . | |
| date. | | |
| 9.1.1.4 21 Are you having contractions? | 9.1.1.4.1 -1 Yes | 9.1.1.4.2 -1 No |
| 9.1.1.5 20 Are you feeling the baby more normally? | 9.1.1.5.1 -1 Yes | 9.1.1.5.2 -1 No |
| 9.1.1.6 141 Have you noticed any vaginal bleeding? | 9.1.1.6.1 -1 Yes | 9.1.1.6.2 -1 No |
| 9.1.1.7 140 Have you noticed any leakage of fluid? | 9.1.1.7.1 -1 Yes | 9.1.1.7.2 -1 No |
| 9.1.1.8 142 Have you ruptured your bag of waters? | 9.1.1.8.1 -1 Yes | 9.1.1.8.2 -1 No |
| 9.1.1.9 101 Have you been seeing a doctor during | 9.1.1.9.1 -1 Yes | 9.1.1.9.2 -1 No |
| your pregnancy? | | |
| 9.1.1.10 103 Have you been taking prenatal | 9.1.1.10.1 -1 Yes | 9.1.1.10.2 -1 No |
| vitamins? | | |
| 9.1.1.11 121 Have you had any complications with | 9.1.1.11.1 -1 Yes | 9.1.1.11.2 -1 No |
| this pregnancy? | | 9.1.2 -1 No |
| 9.2 159 Is there any chance you could be pregnant? | 9.2.1 -1 Yes | 9.2.2 -1 No |
| 9.3 106 Have you ever been pregnant before? | 9.3.1 -1 Yes | |
| 9.3.1.1 144 How many times have you been | 9.3.1.1.1 -1 . . . | |
| pregnant? | | |
| 9.3.1.2 121 Have you had any complications with | 9.3.1.2.1 -1 Yes | |
| this pregnancy? | | |
| 9.3.1.2.1.1 54 Did you have bleeding problems? | 9.3.1.2.1.1.1 -1 | 9.3.1.2.1.1.2 -1 |
| | Yes | No |
| 9.3.1.2.1.2 55 Did you have high sugars? | 9.3.1.2.1.2.1 -1 | 9.3.1.2.1.2.2 -1 |
| | Yes | No |
| 9.3.1.2.1.3 56 Did you have to deliver emergently? | 9.3.1.2.1.3.1 -1 | 9.3.1.2.1.3.2 -1 |
| | Yes | No |
| | | 9.3.1.2.2 -1 No |
| 9.3.1.3 120 Have you had an abortion before? | 9.3.1.3.1 -1 Yes | 9.3.1.3.2 -1 No |
| 9.3.1.4 115 Have you ever had a stillbirth? | 9.3.1.4.1 -1 Yes | 9.3.1.4.2 -1 No |
| 9.3.1.5 114 Have you ever had a miscarriage? | 9.3.1.5.1 -1 Yes | 9.3.1.5.2 -1 No |
| 9.3.1.6 111 Have you ever had a cesarean delivery? | 9.3.1.6.1 -1 Yes | 9.3.1.6.2 -1 No |
| | | 9.3.2 -1 No |
| 9.4 201 What was the date of your last Pap smear? | 9.4.1 -1 . . . | |
| 9.5 202 What was the first day of your last menstrual | 9.5.1 -1 . . . | |
| cycle? | | |
| 10 -1 Physical Exam | | |
| 10.1 96 Don't move | 10.1.1 -1 . . . | |
| 10.2 178 Relax | 10.2.1 -1 . . . | |
| 10.3 177 Quiet please | 10.3.1 -1 . . . | |
| 10.4 163 Please be still | 10.4.1 -1 . . . | |
| 10.5 179 Sit down | 10.5.1 -1 . . . | |
| 10.6 160 Lie down | 10.6.1 -1 . . . | |
| 10.7 181 Stand up | 10.7.1 -1 . . . | |
| 10.8 186 Take off your shirt | 10.8.1 -1 . . . | |
| 10.9 185 Take off your pants | 10.9.1 -1 . . . | |
| 10.10 176 Put this on | 10.10.1 -1 . . . | |
| 10.11 190 Turn over | 10.11.1 -1 . . . | |
| 10.12 189 Turn onto your side | 10.12.1 -1 . . . | |
| 10.13 161 Open your eyes | 10.13.1 -1 . . . | |
| 10.14 162 Open your mouth | 10.14.1 -1 . . . | |
| 10.15 182 Stick out your tongue | 10.15.1 -1 . . . | |
| 10.16 47 Bend your head forward | 10.16.1 -1 . . . | |
| 10.17 184 Take a deep breath | 10.17.1 -1 . . . | |
| 10.18 164 Please don't talk | 10.18.1 -1 . . . | |
| 10.19 48 Breath normally | 10.19.1 -1 . . . | |
| 10.20 49 Cough | 10.20.1 -1 . . . | |
| 10.21 98 Follow my finger with your eyes | 10.21.1 -1 . . . | |
| 10.22 97 Don't move your head | 10.22.1 -1 . . . | |
| 10.23 60 Do exactly what I am doing | 10.23.1 -1 . . . | |
| 10.24 180 Squeeze my fingers | 10.24.1 -1 . . . | |
| 10.25 183 Swallow | 10.25.1 -1 . . . | |
| 10.26 188 Touch your chin to your chest | 10.26.1 -1 . . . | |
| 10.27 191 Walk slowly back and forth | 10.27.1 -1 . . . | |
| 10.28 151 I am going to exam your eyes | 10.28.1 -1 . . . | |
| 10.29 150 I am going to exam your ears | 10.29.1 -1 . . . | |
| 10.30 154 I am going to exam your heart | 10.30.1 -1 . . . | |
| 10.31 155 I am going to exam your lungs | 10.31.1 -1 . . . | |
| 10.32 148 I am going to exam your abdomen | 10.32.1 -1 . . . | |
| 10.33 149 I am going to exam your breasts | 10.33.1 -1 . . . | |
| 10.34 153 I am going to exam your genital area | 10.34.1 -1 . . . | |
| 10.35 156 I am going to exam your rectum | 10.35.1 -1 . . . | |
| 10.36 152 I am going to exam your feet | 10.36.1 -1 . . . | |
| 10.37 157 I am going to exam your vaginal area | 10.37.1 -1 . . . | |

It will be understood that the questions and statements as seen in Table 1, above, are exemplary and not limiting in nature. The number and nature of the questions, categories and statements in any given embodiment of the invention will be dictated by the intended use and objectives of the device and method.

The foregoing detailed description of the invention is intended to be illustrative and not intended to limit the scope of the invention. Changes and modifications are possible with respect to the foregoing description, and it is understood that the invention may be practiced otherwise than that specifically described herein and still be within the scope of the claims.

What is claimed is:

1. An apparatus for providing communication between a service provider and a service receiver, wherein said service provider understands a different language than the service receiver speaks, comprising: a microprocessor, a random access memory, a program storage, a data storage, at least one input device, at least one output device, and a software program that stores pre-translated questions, such questions enabling communication between said service provider and said service receiver.

2. The apparatus in claim 1 wherein the apparatus comprises a computer, handheld computer, laptop or Tablet PC, stand-alone embedded system.

3. The apparatus in claim 1 wherein the input device comprises a physical keyboard, software keyboard, microphone, touch screen, character recognition.

4. The apparatus in claim 1 wherein the program storage comprises an EPROM, EEPROM, EAPROM.

5. The apparatus in claim 1 wherein the output device comprises a display screen, speaker.

6. The apparatus in claim 1 further comprising a communications device and related hardware for transmitting data through a wired or wireless connection.

7. The apparatus in claim 1 wherein the pre-translated questions are displayed on the output device both visually and audibly.

8. The apparatus in claim 1 wherein the program storage, and data storage comprises a hard drive.

9. The apparatus in claim 1 wherein the program storage comprises a CD-ROM, Mini Disc or DVD.

10. The apparatus in claim 6 wherein the communications device comprises a serial RS-232 port, a connection to the Internet, Bluetooth, IEEE 802.11a, IEEE 802.11b, or IEEE 802.11g.

11. A system for providing communication between a service provider and a service receiver, wherein said service provider understands a different language than the service receiver speaks, comprising: at least two, each device comprising a microprocessor, a random access memory, a program storage, a data storage, at least one input device, at least one output device, and a software program that stores pre-translated questions, such questions enabling communication between said service provider and said service receiver.

12. The system in claim 11 wherein the at least two devices comprise a computer, handheld computer, laptop or Tablet PC, stand-alone embedded system.

13. The system in claim 11 wherein the input device comprises a physical keyboard, software keyboard, microphone, touch screen, character recognition.

14. The system in claim 11 wherein the program storage is an EPROM, EEPROM, EAPROM.

15. The system in claim 11 wherein the output device comprises a display screen, speaker.

16. The system in claim 11 further comprising a communications device and related hardware for transmitting data through a wired or wireless connection.

17. The system in claim 11 wherein the pre-translated questions are displayed on the output device both visually and audibly.

18. The system in claim 11 wherein the program storage, and data storage comprises a hard drive.

19. The system in claim 11 wherein the program storage comprises a CD-ROM, Mini Disc or DVD.

20. The system in claim 16 wherein the communications device comprises a serial RS-232 port, a connection to the Internet, Bluetooth, IEEE 802.11a, IEEE 802.11b, or IEEE 802.11g.

21. An apparatus comprising a microprocessor, a program storage, a data storage, and a communication device that stores pre-translated questions in both textual and sound formats for use in enabling communication between a service provider and a service receiver that do not speak the same language.

22. A method of communicating between a service provider and a service receiver that speak and understand different languages using an apparatus for providing communication between a service provider and a service receiver, which comprises a microprocessor, a random access memory, a program storage, a data storage, at least one input device, at least one output device, and a software program that stores pre-translated questions, such questions enabling communication between said service provider and said service receiver, the steps comprising:
a) providing questions in a language that is understood by the service receiver;
b) answering said questions in a language that is understood by the service receiver;
c) providing information to said service provider in a language understood by said service provider, based on the answers provided by the service receiver; wherein said language understood by said service provider is different from the language understood by said service receiver.

23. The apparatus and method claimed in claims 1, 11, 21 and 22, wherein said service provider is a doctor, and said service receiver is a patient.

24. A method of communicating between a service provider and a service receiver that speak and understand different languages using an apparatus for providing communication between a service provider and a service receiver, which comprises a microprocessor, a random access memory, a program storage, a data storage, at least one input device, at least one output device, and a software program that stores pre-translated questions, such questions enabling communication between the service provider and the service receiver, the steps comprising:
a) determining the language of the service receiver;
b) transmitting one or more of predetermined questions and statements based on said determining of the service reader language in one or both of text and audio formats;
c) collecting responses from the service receiver based on said transmitting of the one or more questions and statements; and
d) providing information to said service provider in a language understood by said service provider, based on said colleting of the responses; wherein the language understood by the service provider is different from the language understood by the service receiver.

25. The method of claim 24 further comprising:
e) receiving one or more question from the service provider; and
f) transmitting the one or more service provider question to the service receiver in the service receiver language.

26. The method of claim 25 further comprising:
g) providing the service receiver one or more of advice, explanations, examinations, tests and procedures in the service receiver language.

27. The method of claim 23 wherein said collection of responses includes the collection of the personal and medical data of the service receiver.

28. The method of claim 27 further comprising storing the personal and medical data.

29. The method of claim 28 wherein said storing of the personal and medical data comprises storing the personal and medical and providing a copy of the stored personal and medical data to the service receiver.

30. The method of claim 29 wherein the copy is provided in an electronic format.
